(19) United States
(12) Patent Application Publication
(10) Pub. No.: US 2026/0021618 A1
(43) Pub. Date: Jan. 22, 2026

(54) PREPARATION METHOD AND APPLICATION OF POLYTETRAFLUOROETHYLENE STRETCHED FILM

(71) Applicant: JIAXING FREBANG NEW MATERIAL TECHNOLOGY CO., LTD, Jiaxing (CN)

(72) Inventors: Xinglei ZHAO, Jiaxing (CN); Pan JIANG, Jiaxing (CN); Ting HUA, Jiaxing (CN); Peng WANG, Jiaxing (CN)

(73) Assignee: JIAXING FREBANG NEW MATERIAL TECHNOLOGY CO., LTD, Jiaxing (CN)

(21) Appl. No.: 19/342,497

(22) Filed: Sep. 27, 2025

Related U.S. Application Data
(63) Continuation-in-part of application No. 18/827,019, filed on Sep. 6, 2024.

(51) Int. Cl. B29C 48/08; B29C 35/02; B29C 48/00; B29K 96/02; C08F 2/24; C08F 220/24; C08F 265/04

(52) U.S. Cl. CPC B29C 48/08; B29C 35/02; B29C 48/0011; B29C 48/0018; B29C 48/022; C08F 2/24; C08F 265/04; B29K 2096/02; B29K 2995/0053; B29K 2995/0077; C08F 220/24

(57) ABSTRACT

A preparation method of the polytetrafluoroethylene stretched film comprises: (1) uniformly mixing a modified polytetrafluoroethylene emulsion and a lubricant, and carrying out extrusion calendaring; and (2) longitudinally stretching and then transversely stretching at a high temperature, and sintering and curing at a high temperature for 5-15 minutes after stretching is completed, to obtain a product, namely the polytetrafluoroethylene stretched film. According to the method, a polymer AOI modified monomer is added, so that the prepared polytetrafluoroethylene stretched film is soft, good in tensile property, small in pore diameter, high in porosity and uniform in pore diameter distribution. In addition, an ammonium salt polymer dispersant is used as a preparation raw material, and a product of the ammonium salt polymer dispersant is green and clean, does not cause environmental pollution and does not participate in human metabolism.

### CROSS-REFERENCE TO RELATED APPLICATIONS

This application is a continuation-in-part of U.S. patent application Ser. No. 18/827,019 with a filing date of Sep. 6, 2024 which is a continuation of International Patent Application No. PCT/CN2023/122379 with a filing date of Sep. 28, 2023, designating the United States, now pending, and further claims priority to Chinese Patent Application No. 202211246676.X with a filing date of Oct. 12, 2022. The content of the aforementioned applications, including any intervening amendments thereto, is incorporated herein by reference.

### TECHNICAL FIELD

The prevent disclosure relates to the field of filter material technologies, and provides a preparation method and application of a polytetrafluoroethylene stretched film.

### BACKGROUND

Polytetrafluoroethylene (Teflon or PTFE), commonly known as the “Plastic King”, is a high molecular compound polymerized by tetrafluoroethylene. Due to its special molecular structure, it has extremely good chemical stability as well as extremely broad temperature resistance, and can be used for a long time in a temperature range of −180° C. to 260° C., which is difficult for any other polymer materials to achieve. In addition, it also has excellent corrosion resistance and leakproofness, high lubricating performance and non-sticky performance, electrical insulation, and good aging resistance, and is known as the “Plastic King” in the industry. Since its invention by Dr. Planket in 1938, PTFE has revolutionized the plastics industry.

A film technology has been greatly developed in the last 50 to 60 years, and has been widely used in people's life, the industrial field, and scientific research. Microporous films made of various organic polymer materials have been successively developed, such as cellulose acetate, polyamide, polysulfone, nylon 66, polyethersulfone, polyvinylidene fluoride, polyethylene, and polypropylene. Except for the polyethylene and polypropylene that are microporous films prepared by a stretching method, most of other casting film solutions are made of polymer materials, specific solvents, and additives by a phase inversion method. Common disadvantages of these polymer materials are that a use temperature is limited, and the polymer materials are not resistant to acids, alkali, and chemicals.

A polytetrafluoroethylene microporous stretched film (known abroad as expanded polytetrafluoroethylene, ePTFE) developed in the 1970s overcomes the disadvantages of the above-mentioned traditional film materials, and is widely used in various harsh environments as an ideal material for preparing a high-performance microporous film. The PTFE stretch microporous film was originally developed by Gore Company of the United States. It uses PTFE fine powder to form fibers from powdery particles through a series of mechanical stretching operations such as extrusion calendaring and stretching, and the fibers are interwoven into a network structure. The film has 9 billion micropores per square centimeter, with characteristics of a small pore diameter, uniform pore diameter distribution, a low relative density, high film strength, a smooth surface, and the like.

The polytetrafluorocthylene microporous film is not changed at all in original characteristic as it is mechanically stretched under special conditions without adding any substances into tetrafluoroethylene. Therefore, the polytetrafluoroethylene microporous film still features a wide use temperature range, chemical corrosion resistance, a small film material coefficient, biocompatibility, hydrophobicity, and the like, is widely used in dust removal and sterilization in the pharmaceutical industry, product purification and material recovery in air, waterproof and moisture-permeable textiles, water treatment, food health, biomedicine, filtration separation, and the like, and is especially irreplaceable as a filter material due to its dominant position. Correspondingly, basic and application research on the polytetrafluoroethylene microporous film is also common. Research by the majority of scientific researchers focuses on obtaining a new polytetrafluoroethylene microporous film material with high comprehensive performance and multifunctionality by selecting different filling materials and proper modification methods.

Chinese Patent Application No. CN112108008A provides a polytetrafluoroethylene biaxially stretched film and a preparation method and an application thereof. A PET stretched film, which is prepared by co-extruding and stretching at least two layers of film substrates, and then carrying out curing and shaping at a high temperature, has a small pore diameter and a high porosity, and fails to resolve the environmental pollution problem. Chinese Patent No. CN104448637B provides a preparation method of a polytetrafluoroethylene film for air filtration. A prepared polytetrafluoroethylene film has high porosity, uniform pore diameter distribution and a small thickness, but its tensile property needs to be further improved. An existing polytetrafluoroethylene film is difficult to meet requirements of a small pore diameter, uniform distribution, and high mechanical strength at the same time.

Therefore, to better meet the needs of real life, it is necessary to provide a polytetrafluoroethylene stretched film with a small pore diameter, high porosity, uniform pore diameter distribution, environmental protection, safety, and an excellent tensile property.

### SUMMARY

To resolve the problems in the prior art, the present disclosure aims to provide a polytetrafluoroethylene stretched film with a small pore diameter, high porosity, uniform pore diameter distribution, environmental protection, safety, and an excellent tensile property, to meet needs of actual production and application.

To achieve the objective, the present disclosure adopts the following technical solution.

The present disclosure provides a preparation method of a polytetrafluoroethylene stretched film, and the preparation method of the polytetrafluoroethylene stretched film includes the following steps:
uniformly mixing a modified polytetrafluoroethylene emulsion and a lubricant, and carrying out extrusion calendaring; and
longitudinally stretching and then transversely stretching at a first temperature, and sintering and curing at a second temperature for 5-15 minutes after stretching is completed, to obtain a product, namely the polytetrafluoroethylene stretched film.

In the preparation method of the polytetrafluoroethylene stretched film provided in the present disclosure, the lubricant is polytetrafluoroethylene (PTFE).

In the preparation method of the polytetrafluoroethylene stretched film provided in the present disclosure, usage amount of the lubricant is 10-15% of mass of the modified polytetrafluoroethylene emulsion (for example, may be, 10%, 10.1%, 10.2%, 10.3%, 10.4%, 10.5%, 10.6%, 10.7%, 10.8%, 0.9%, 1%, 1.1%, 1.2%, 1.3%, 1.4%, 1.5%, 1.6%, 1.7%, 1.8%, 1.9%, 12%, 12.1%, 12.2%, 12.3%, 12.4%, 12.5%, 12.6%, 12.7%, 12.8%, 12.9%, 13%, 13.1%, 13.2%, 13.3%, 13.4%, 13.5%, 13.6%, 13.7%, 13.8%, 13.9%, 14%, 14.1%, 14.2%, 14.3%, 14.4%, 14.5%, 14.6%, 14.7%, 14.8%, 14.9%, 15% or any value thereof).

In the preparation method of the polytetrafluoroethylene stretched film provided in the present disclosure, the first temperature is 210-230° C. (for example, may be 210° C., 211° C., 212° C., 213° C., 214° C., 215° C., 216° C., 217° C., 218° C., 219° C., 220° C., 221° C., 222° C., 223° C., 224° C., 225° C., 226° C., 227° C., 228° C., 229° C., 230° C. or any value thereof). The second temperature is 350-370° C. (for example, may be 350° C., 351° C., 352° C., 353° C., 354° C., 355° C., 356° C., 357° C., 358° C., 359° C., 360° C., 361° C., 362° C., 363° C., 364° C., 365° C., 366° C., 367° C., 368° C., 369° C., 370° C. or any value thereof).

In some embodiments of the prevent disclosure, the modified polytetrafluoroethylene emulsion includes the following raw materials in parts by weight: 0.5-2 parts of an ammonium salt polymer dispersant, 0.2-1 part of an emulsifier, 1-1.5 parts of a 2-isocyanatoethyl acrylate (AOI) modified monomer, 0.5-3 parts of an initiator, 40-60 parts of a tetrafluoroethylene monomer, and 30-60 parts of water.

In some embodiments of the prevent disclosure, a structure of the ammonium salt polymer dispersant is as follows:

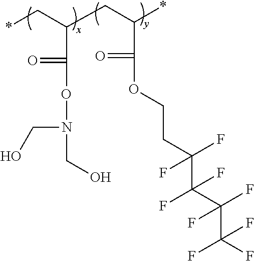

where x is an integer of 2-5, y is an integer of 5-8, and * is a connection site of a chemical bond.

In some embodiments of the prevent disclosure, a preparation method of the ammonium salt polymer dispersant includes the following steps:

adding a solvent into a reactor, heating up to a third temperature, and dropwise adding perfluorohexanol acrylate, acrylic acid, and an initiator into the reactor, and keeping the third temperature to react for 2-4 hours; and
adding diethanolamine into a product obtained above step for reaction, removing the solvent after the reaction ends to obtain the ammonium salt polymer dispersant.

In the preparation method of the ammonium salt polymer dispersant provided in the present disclosure, a molar ratio of the perfluorohexanol acrylate, the acrylic acid and the diethanolamine is (1-4):1:1 (for example, may be 1 to 1 to 1, 2 to 1 to 1, 3 to 1 to 1, 4 to 1 to 1 or any value thereof).

In the preparation method of the ammonium salt polymer dispersant provided in the present disclosure, the third temperature is 60-70° C. (for example, may be 60° C., 61° C., 62° C., 63° C., 64° C., 65° C., 66° C., 67° C., 68° C., 69° C., 70° C. or any value thereof). The solvent is selected from one or more of perfluorohexane, perfluoroheptane, perfluorooctane, and bromododecafluorohexane. The initiator is selected from one or a combination of perfluorobutyryl peroxide and perfluorohexanoyl peroxide. Usage amount of the initiator is 1%- 2% (for example, may be 1%, 1.1%, 1.2%, 1.3%, 1.4%, 1.5%, 1.6%, 1.7%, 1.8%, 1.9%, 2% or any value thereof) of total mass of the perfluorohexanol acrylate and the acrylic acid.

In some embodiments of the present disclosure, the emulsifier is perfluoropolyether (PEPE).

In some embodiments of the present disclosure, the initiator is one or a combination of perfluorobutyryl peroxide and perfluorohexanoyl peroxide.

In some embodiment of the prevent disclosure, a structure of the AOI modified monomer is as follows:

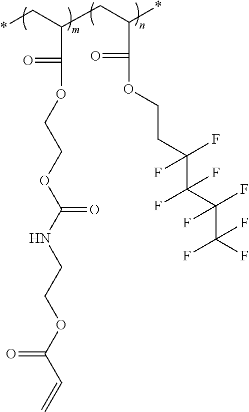

where m is an integer of 1-2, n is an integer of 10-20, and * is a connection site of a chemical bond.

In some embodiments of the prevent disclosure, a preparation method of the AOI modified monomer includes the following steps:
adding a solvent into a reactor, heating up to a fourth temperature, and dropwise adding the perfluorohexanol acrylate, hydroxyethyl acrylate, and an initiator into the reactor, and keeping the fourth temperature for 2-4 hours after dropwise adding is completed; and
adding AOI into a product obtained in above step for reaction, removing the solvent after the reaction ends, to obtain the AOI modified monomer.

In the preparation method of the AOI modified monomer provided in the present disclosure, a molar ratio of the perfluorohexanol acrylate, the hydroxyethyl acrylate and the AOI is (10-20):1:1, (for example, may be 10 to 1 to 1, 11 to 1 to 1, 12 to 1 to 1, 13 to 1 to 1, 14 to 1 to 1, 15 to 1 to 1, 16 to 1 to 1, 17 to 1 to 1, 18 to 1 to 1, 19 to 1 to 1, 20 to 1 to 1 or any value thereof).

In the preparation method of the AOI modified monomer provided in the present disclosure, the fourth temperature is 60-70° C. (for example, may be 60° C., 61° C.,62° C., 63° C., 64° C., 65° C., 66° C., 67° C., 68° C., 69° C., 70° C. or any value thereof). The solvent is selected from one or more of perfluorohexane, perfluoroheptane, perfluorooctane, and bromododecafluorohexane. The initiator is selected from one or a combination of perfluorobutyryl peroxide and perfluorohexanoyl peroxide. Usage amount of the initiator is 1%- 2% (for example, may be 1%, 1.1%, 1.2%, 1.3%, 1.4%, 1.5%, 1.6%, 1.7%, 1.8%, 1.9%, 2% or any value thereof) of total mass of the perfluorohexanol acrylate and the acrylic acid.

In some embodiments of the prevent disclosure, a preparation method of the modified polytetrafluoroethylene emulsion includes the following steps:
adding the dispersant, the emulsifier and deionized water into a high-pressure emulsification reactor, stirring, heating up to 40-60° C., and increasing system pressure to 3-4 MPa; and
respectively adding the tetrafluoroethylene monomer, the AOI modified monomer, and the initiator into the high-pressure emulsification reactor, heating up and reacting for 2-4 h after reaction is completed to obtain the modified polytetrafluoroethylene emulsion.

Compared with the prior art, the present disclosure has the following beneficial effects:

The polytetrafluoroethylene stretched film provided in the present disclosure, by adding the AOI modified monomer, affects an overall structure of the polytetrafluoroethylene stretched film, reduces system crystallinity, and makes the obtained polytetrafluoroethylene stretched film soft and have good stretching performance. In addition, thepolytetrafluoroethylene stretched film has a small pore diameter, high porosity, and uniform pore diameter distribution.

In the preparation method of the polytetrafluoroethylene stretched film provided in the present disclosure, the ammonium salt polymer dispersant is used as the preparation raw material to achieve good stability of a product. A product of the ammonium salt polymer dispersant is green and clean, does not cause environmental pollution, and does not participate in human metabolism. Therefore, compared with a method in which perfluoric acid and a salt thereof are used as a production auxiliary agent in the market at present, the preparation method in the present disclosure is a very environment-friendly and healthy technical solution.

### DETAILED DESCRIPTION

The present disclosure will be described below in combination with specific embodiments. It should be noted that the following embodiments are examples of the present disclosure, and are only used to illustrate the present disclosure, not to limit the present disclosure. Other combinations and various modifications within the concept of the present disclosure can be made without departing from the spirit or scope of the present disclosure.

In the following embodiments, compounds and related reagents that are used can be purchased from the market. AOI can be purchased from Japan Showa Denko Co., Ltd.

### Preparation of Ammonium Salt Polymer Dispersant I

A preparation method includes the following steps.

Add 100 g of perfluoroheptane into a reactor, increase a temperature to 70° C., dropwise add 1 mol of perfluorohexanol acrylate, 1 mol of acrylic acid, and 1 g of perfluorobutyryl peroxide into the reactor at a constant speed through a peristaltic pump, and keep the temperature to react for 4 hours after dropwise adding is completed.

Add 1 mol of diethanolamine into the reactor, keep the temperature at 70° C. for reaction, remove the perfluoroheptane after the reaction is completed, to obtain a product, namely, the ammonium salt polymer dispersant I.

### Preparation of Ammonium Salt Polymer Dispersant II

A preparation method includes the following steps.

Add 100 g of perfluoroheptane into a reactor, increase a temperature to 70° C., dropwise add 4 mol of perfluorohexanol acrylate, 1 mol of acrylic acid, and 1 g of perfluorobutyryl peroxide into the reactor at a constant speed through a peristaltic pump, and keep the temperature to react for 4 hours after dropwise adding is completed.

Add 1 mol of diethanolamine into the reactor, keep the temperature at 70° C. for reaction, remove the perfluoroheptane after the reaction is completed, to obtain a product, namely, the ammonium salt polymer dispersant II.

### Preparation of AOI Modified Monomer I

A preparation method includes the following steps.

Add 100 g of perfluoroheptane into a reactor, increase a temperature to 70° C., dropwise add 1 mol of perfluorohexanol acrylate, 0.1 mol of hydroxyethyl acrylate, and 1 g of perfluorobutyryl peroxide into the reactor at a constant speed through a peristaltic pump, and keep the temperature to react for 4 hours after dropwise adding is completed.

Add 0.1 mol of AOI into the product obtained in above step for reaction, remove perfluoroheptane after the reaction ends, to obtain a product, namely the AOI modified monomer I.

### Preparation of AOI Modified Monomer II

A preparation method includes the following steps.

Add 100 g of perfluoroheptane into a reactor, increase a temperature to 70° C., dropwise add 2 mol of perfluorohexanol acrylate, 0.1 mol of hydroxyethyl acrylate, and 1 g of perfluorobutyryl peroxide into the reactor at a constant speed through a peristaltic pump, and keep the temperature to react for 4 hours after dropwise adding is completed.

Add 0.1 mol of AOI into the product obtained in above step for reaction, remove perfluoroheptane after the reaction ends, to obtain a product, namely the AOI modified monomer II.

### Modified Polytetrafluoroethylene Emulsion I

A modified polytetrafluoroethylene emulsion includes the following raw materials in parts by weight: 2 parts of an ammonium salt polymer dispersant II, 1 part of an emulsifier, e.g. perfluoropolyether (PEPE), 1.5 parts of an AOI modified monomer II, 3 parts of perfluorobutyryl peroxide, 60 parts of a tetrafluoroethylene monomer, and 30 parts of deionized water.

A preparation method includes the following steps.

Add the ammonium salt polymer dispersant II, the emulsifier and deionized water into a high-pressure emulsification reactor, carry out stirring, heat up to 60° C., and add nitrogen gas to increase system pressure to 4 MPa.

Respectively add the tetrafluoroethylene monomer, the AOI modified monomer II, and the perfluorobutyryl peroxide into the high-pressure emulsification reactor, heat up and react for 3 h after reaction is completed, to obtain a product, namely, the modified polytetrafluoroethylene emulsion I.

### Modified Polytetrafluoroethylene Emulsion II

A modified polytetrafluoroethylene emulsion includes the following raw materials in parts by weight: 0.5 part of an ammonium salt polymer dispersant II, 1 part of the emulsifier, 1.5 parts of an AOI modified monomer II, 3 parts of perfluorobutyryl peroxide, 60 parts of a tetrafluoroethylene monomer, and 30 parts of deionized water.

A preparation method of the modified polytetrafluoroethylene emulsion II is the same as that of the modified polytetrafluoroethylene emulsion I.

### Modified Polytetrafluoroethylene Emulsion III

A modified polytetrafluoroethylene emulsion includes the following raw materials in parts by weight: 0.5 part of an ammonium salt polymer dispersant II, 1 part of the emulsifier, 1 part of an AOI modified monomer II, 3 parts of perfluorobutyryl peroxide, 60 parts of a tetrafluoroethylene monomer, and 30 parts of deionized water.

A preparation method of the modified polytetrafluoroethylene emulsion III is the same as that of the modified polytetrafluoroethylene emulsion I.

### Modified Polytetrafluoroethylene Emulsion IV

A modified polytetrafluoroethylene emulsion includes the following raw materials in parts by weight: 0.5 part of an ammonium salt polymer dispersant I, 1 part of the emulsifier, 1 part of an AOI modified monomer II, 3 parts of perfluorobutyryl peroxide, 60 parts of a tetrafluoroethylene monomer, and 30 parts of deionized water.

A preparation method of the modified polytetrafluoroethylene emulsion IV is the same as that of the modified polytetrafluoroethylene emulsion I.

### Modified Polytetrafluoroethylene Emulsion V

A modified polytetrafluoroethylene emulsion includes the following raw materials in parts by weight: 0.5 part of an ammonium salt polymer dispersant I, 1 part of the emulsifier, 1 part of an AOI modified monomer I, 3 parts of perfluorobutyryl peroxide, 60 parts of a tetrafluoroethylene monomer, and 30 parts of deionized water.

A preparation method of the modified polytetrafluoroethylene emulsion V is the same as that of the modified polytetrafluoroethylene emulsion I.

### Modified Polytetrafluoroethylene Emulsion VI

A modified polytetrafluoroethylene emulsion includes the following raw materials in parts by weight: 0.5 part of an ammonium salt polymer dispersant I, 1 part of the emulsifier, 1 part of an AOI modified monomer I, 3 parts of perfluorobutyryl peroxide, 40 parts of a tetrafluoroethylene monomer, and 30 parts of deionized water.

A preparation method of the modified polytetrafluoroethylene emulsion VI is the same as that of the modified polytetrafluoroethylene emulsion I.

### Modified Polytetrafluoroethylene Emulsion VII

A modified polytetrafluoroethylene emulsion includes the following raw materials in parts by weight: 0.5 part of an ammonium salt polymer dispersant I, 0.2 part of the emulsifier, 1 part of an AOI modified monomer I, 3 parts of perfluorobutyryl peroxide, 40 parts of a tetrafluoroethylene monomer, and 30 parts of deionized water.

A preparation method of the modified polytetrafluoroethylene emulsion VII is the same as that of the modified polytetrafluoroethylene emulsion I.

### Modified Polytetrafluoroethylene Emulsion VIII

A modified polytetrafluoroethylene emulsion includes the following raw materials in parts by weight: 0.5 part of an ammonium salt polymer dispersant I, 0.2 part of the emulsifier, 1 part of an AOI modified monomer I, 1 part of perfluorobutyryl peroxide, 40 parts of a tetrafluoroethylene monomer, and 30 parts of deionized water.

A preparation method of the modified polytetrafluoroethylene emulsion VIII is the same as that of the modified polytetrafluoroethylene emulsion I.

### Modified Polytetrafluoroethylene Emulsion IX

A modified polytetrafluoroethylene emulsion includes the following raw materials in parts by weight: 0.5 part of an ammonium salt polymer dispersant I, 0.2 part of the emulsifier, 1 part of an AOI modified monomer I, 1 part of perfluorobutyryl peroxide, 40 parts of a tetrafluoroethylene monomer, and 60 parts of deionized water.

A preparation method of the modified polytetrafluoroethylene emulsion IX is the same as that of the modified polytetrafluoroethylene emulsion I.

### Embodiment 1

A polytetrafluoroethylene stretched film is prepared from the following method.

Uniformly mix 100 g of the modified polytetrafluoroethylene emulsion I and 15 g of a lubricant, e.g. PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

For a structural diagram of the polytetrafluoroethylene stretched film, refer to FIG. 1.

### Embodiment 2

A polytetrafluoroethylene stretched film is prepared from the following method.

Uniformly mix 100 g of a modified polytetrafluoroethylene emulsion II and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 3

A polytetrafluoroethylene stretched film is prepared from the following method.

Uniformly mix 100 g of a modified polytetrafluoroethylene emulsion III and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 4

A polytetrafluoroethylene stretched film is prepared from the following method.

Uniformly mix 100 g of a modified polytetrafluoroethylene emulsion IV and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 5

A polytetrafluoroethylene stretched film is prepared from the following method.

Uniformly mix 100 g of a modified polytetrafluoroethylene emulsion V and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 6

A polytetrafluoroethylene stretched film is prepared from the following method.

Uniformly mix 100 g of a modified polytetrafluoroethylene emulsion VI and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 7

A polytetrafluoroethylene stretched film is prepared from the following method.

Uniformly mix 100 g of a modified polytetrafluoroethylene emulsion VII and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 8

A polytetrafluoroethylene stretched film is prepared from the following method.

Uniformly mix 100 g of a modified polytetrafluoroethylene emulsion VIII and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 9

A polytetrafluoroethylene stretched film is prepared from the following method.

Uniformly mix 100 g of a modified polytetrafluoroethylene emulsion IX and 15 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Embodiment 10

A polytetrafluoroethylene stretched film is prepared from the following method.

Uniformly mix 100 g of a modified polytetrafluoroethylene emulsion IX and 10 g of the PTFE, and carry out extrusion calendaring.

Longitudinally stretch and then transversely stretch at a temperature of 220° C., and sinter and cure at a temperature of 360° C. for 10 minutes after stretching is completed, to obtain a product, namely the polytetrafluoroethylene stretched film.

### Comparative Example 1

The difference between comparative example 1 and embodiment 1 lies in that no AOI modified monomer is used in raw materials of the polytetrafluoroethylene emulsion when preparing the polytetrafluoroethylene stretched film.

### Comparative Example 2

The difference between comparative example 2 and embodiment 1 lies in that usage amount of the lubricant, PTFE, is 3 g when preparing the polytetrafluoroethylene stretched film.

The polytetrafluoroethylene stretched film prepared by the above-mentioned embodiments and comparative examples is tested for performance, test of tensile strength and elongation at break is carried out according to the requirements of the GB/T1040.3-2006 standard, a porosity is tested by using a porosity tester, a pore diameter and pore diameter distribution are measured by using an SEM scanning electron microscope, and the test results are shown in Table 1:

TABLE 1
Related Index Test Results of a Polytetrafluoroethylene
Stretched film in Embodiments and Comparative Examples

| | Elongation | | Tensile | | | Average | |
|---|---|---|---|---|---|---|---|
| | at break | | strength | | Poros- | pore | Pore |
| Serial | (%) | | (MPa) | | ity | diameter | diameter |
| number | MD | TD | MD | TD | (%) | (μm) | distribution |
| Embodiment | 135.7 | 139.8 | 97.3 | 105.8 | 85 | 0.25 | Uniform |
| 1 | | | | | | | |
| Embodiment | 135.1 | 138.1 | 96.9 | 105.4 | 84 | 0.26 | Uniform |
| 2 | | | | | | | |
| Embodiment | 134.8 | 137.8 | 96.7 | 105.2 | 85 | 0.26 | Uniform |
| 3 | | | | | | | |
| Embodiment | 134.2 | 137.3 | 96.4 | 104.8 | 85 | 0.27 | Uniform |
| 4 | | | | | | | |
| Embodiment | 133.7 | 136.8 | 96.1 | 104.5 | 84 | 0.28 | Uniform |
| 5 | | | | | | | |
| Embodiment | 132.5 | 135.2 | 95.8 | 104.0 | 83 | 0.29 | Uniform |
| 6 | | | | | | | |
| Embodiment | 131.6 | 133.9 | 95.6 | 103.7 | 83 | 0.31 | Uniform |
| 7 | | | | | | | |
| Embodiment | 130.1 | 132.1 | 94.2 | 103.5 | 82 | 0.31 | Uniform |
| 8 | | | | | | | |
| Embodiment | 128.6 | 130.8 | 93.1 | 102.9 | 82 | 0.32 | Uniform |
| 9 | | | | | | | |
| Embodiment | 127.9 | 128.7 | 92.6 | 102.1 | 82 | 0.33 | Uniform |
| 10 | | | | | | | |
| Comparative | 109.6 | 110.5 | 85.3 | 91.8 | 68 | 0.48 | Non- |
| Example 1 | | | | | | | uniform |
| Comparative | 111.9 | 113.5 | 86.8 | 93.1 | 75 | 0.39 | Relatively |
| Example 2 | | | | | | | uniform |

From comparison between the test results of comparative example 1 and embodiment 1, it can be learned that the polytetrafluoroethylene stretched film prepared in Embodiment 1 is effectively improved in tensile strength and elongation at break by adding a polymer AOI modified monomer, so that the polytetrafluoroethylene stretched film has a good tensile property, a small pore diameter, a high porosity, and uniform pore diameter distribution. From comparison between Comparative Example 2 and Embodiment 1, it can be learned that the polytetrafluoroethylene stretched film prepared in Embodiment 1 can improve the tensile property by adding an appropriate amount of lubricant. From comprehensive comparison between Comparative Example and Embodiment, it can be learned that an overall structure of the polytetrafluoroethylene stretched film provided in the present disclosure is affected by adding the polymer AOI modified monomer, and system crystallinity is reduced, so that the prepared polytetrafluoroethylene stretched film is soft, good in tensile property, small in pore diameter, high in porosity and uniform in pore diameter distribution. In addition, an ammonium salt polymer dispersant is used as a preparation raw material, and a product of the ammonium salt polymer dispersant is green and clean, does not cause environmental pollution and does not participate in human metabolism. Therefore, compared with a method in which perfluoric acid and a salt thereof are used as a general production auxiliary agent in the market at present, the preparation method in the present disclosure is a very environment-friendly and healthy technical solution.

The above embodiments are only for describing the technical concept and features of the present disclosure, and the purpose thereof is to allow those familiar with the technology to understand the content of the present disclosure and implement it accordingly. but not to limit the protection scope of the present disclosure. All equivalent changes or modifications made according to the spirit of the present disclosure should be covered within the protection scope of the present disclosure.

What is claimed is:

1. A preparation method of a modified polytetrafluoroethylene stretched film, comprising the following steps:
(1) uniformly mixing a modified polytetrafluoroethylene emulsion and a lubricant, and carrying out extrusion calendaring; and
(2) longitudinally stretching and then transversely stretching at a first temperature, and sintering and curing at a second temperature for 5-15 minutes after stretching is completed, to obtain the modified polytetrafluoroethylene stretched film;
wherein the lubricant in the step (1) is polytetrafluoroethylene (PTFE), and usage amount of the lubricant is 10-15% of mass of the modified polytetrafluoroethylene emulsion; and the first temperature is 210-230° C., and the second temperature is 350-370° C.;
the modified polytetrafluoroethylene emulsion comprises the following raw materials in parts by weight: 0.5-2 parts of an ammonium salt polymer dispersant, 0.2-1 part of an emulsifier, 1-1.5 parts of a 2-isocyanatoethyl acrylate (AOI) modified monomer, 0.5-3 parts of an initiator, 40-60 parts of a tetrafluoroethylene monomer, and 30-60 parts of water;
a preparation method of the modified polytetrafluoroethylene emulsion comprises the following steps:
(1.1) adding the dispersant, the emulsifier and deionized water into a high-pressure emulsification reactor, stirring, heating up to 40-60° C., and increasing system pressure to 3-4 MPa; and
(1.2) respectively adding the tetrafluoroethylene monomer, the AOI modified monomer, and the initiator into the high-pressure emulsification reactor, heating up and reacting for 2-4 h to obtain the modified polytetrafluoroethylene emulsion;
a structure of the ammonium salt polymer dispersant is as follows: 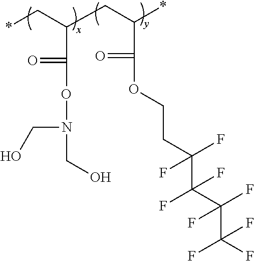
wherein x is an integer of 2-5, y is an integer of 5-8, and * is a connection site of a chemical bond; and
a preparation method of the ammonium salt polymer dispersant comprises the following steps:
(1.1.1) adding a first solvent into a reactor, heating up to a third temperature, and dropwise adding perfluorohexanol acrylate, acrylic acid, and a first initiator into the reactor, and keeping the third temperature to react for 2-4 hours; and
(1.1.2) adding diethanolamine into a product obtained in the step (1.1.1) for reaction, removing the first solvent after the reaction ends to obtain the ammonium salt polymer dispersant;
a structure of the AOI modified monomer is as follows: 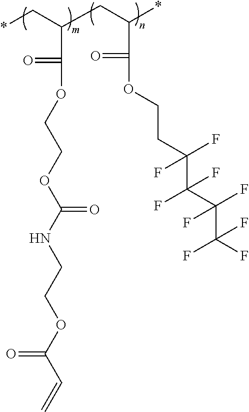
wherein m is an integer of 1-2, n is an integer of 10-20, and * is a connection site of a chemical bond; and
a preparation method of the AOI modified monomer comprises the following steps:
(1.2.1) adding a second solvent into a reactor, heating up to a fourth temperature, and dropwise adding the perfluorohexanol acrylate, hydroxyethyl acrylate, and the initiator into the reactor, and keeping the fourth temperature for 2-4 hours after dropwise adding is completed; and
(1.2.2) adding AOI into a product obtained in step (1.2.1) for reaction, removing the second solvent after the reaction ends, to obtain the AOI modified monomer.

2. The preparation method of the modified polytetrafluoroethylene stretched film according to claim 1, wherein a molar ratio of the perfluorohexanol acrylate, the acrylic acid and the diethanolamine is (1-4):1:1, and the third temperature is 60-70° C.; the first solvent is one or more of perfluorohexane, perfluoroheptane, perfluorooctane, and bromododecafluorohexane; the first initiator is selected from one or more of perfluorobutyryl peroxide and perfluorohexanoyl peroxide; and usage amount of the initiator is 1%- 2% of a total mass of the perfluorohexanol acrylate and the acrylic acid.

3. The preparation method of the modified polytetrafluoroethylene stretched film according to claim 1, wherein the emulsifier is perfluoropolyether (PEPE); and the initiator is one or more of perfluorobutyryl peroxide and perfluorohexanoyl peroxide.

4. The preparation method of the modified polytetrafluoroethylene stretched film according to claim 1, wherein a molar ratio of the perfluorohexanol acrylate, the hydroxyethyl acrylate and the AOI is (10-20):1:1, and the fourth temperature is 60-70° C.; the second solvent is one or more of perfluorohexane, perfluoroheptane, perfluorooctane, and bromododecafluorohexane; the second initiator is selected from one or more of perfluorobutyryl peroxide and perfluorohexanoyl peroxide; and usage amount of the initiator is 1%- 2% of a total mass of the perfluorohexanol acrylate and the acrylic acid.
